(19) United States
(12) Patent Application Publication
(10) Pub. No.: US 2025/0287111 A1
(43) Pub. Date: Sep. 11, 2025

(54) DATA ROUTING FOR MULTIPLE SENSOR SUPPORT

(71) Applicant: QUALCOMM Incorporated, San Diego, CA (US)

(72) Inventors: Mei Yang, San Diego, CA (US); Abhay Raut, San Diego, CA (US); Ajay Nawandhar, San Diego, CA (US)

(21) Appl. No.: 18/596,195

(22) Filed: Mar. 5, 2024

(51) Int. Cl. H04N 23/80; H04N 23/45

(52) U.S. Cl. CPC H04N 23/80; H04N 23/45

(57) ABSTRACT

This disclosure provides systems, methods, and devices for signal processing and routing that support multiple sensors. In a first aspect, a method of data routing includes receiving a first input data stream of a first data characteristic, splitting the first input data stream into a first split data stream and a second split data stream, and transmitting the first split data stream and the second split data stream to a first processing element and a second processing element, respectively. A first split characteristic of the first split data stream and a second split characteristic of the second split data stream are each different from the first data characteristic, and the splitting is performed based on the first input data stream being a first data type. Other aspects and features are also claimed and described.

### TECHNICAL FIELD

Aspects of the present disclosure relate generally to signal processing, and more particularly, to data routing and/or to image processing. Some features may enable and provide improved image processing, including improved circuit and techniques to reduce computational complexity while to support multiple imaging sensors.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Dynamic range may be desirable to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. To achieve high image quality with variation in light levels in a scene, various image sensors can be used to improve photography. However, the amount of image data captured by the image sensor has increased through subsequent generations of image capture devices.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone. In addition, the processing blocks may occupy a bigger area of chip to support the additional image data processing and prevent the image capture device from being smaller due to the additional area that the chip occupies.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, data from one or more image sensors can be routed to one or more circuit blocks for processing of image data output from the image sensors. Appropriately routing the image data from the image sensors allows processing of the image data in circuitry blocks having a smaller processing capability in at least one aspect than the image data. For example, the circuit blocks may be configured to support processing of lower bitwidth data than the bitwidth data supported by the image sensors. As another example, the circuit blocks may be configured to support processing of lower framerate data than the framerate supported by the image sensors. Appropriately routing the data from the image sensor to the circuitry blocks allows the image data to be processed without loss of data despite the circuitry blocks having smaller processing capability. Further, the circuitry blocks with smaller processing capability consume less power and occupy less area in a chip, despite the potential use of more circuitry blocks.

The present disclosure provides systems and methods that support image or signal processing, including techniques for routing an input data stream (e.g., an image data stream) into multiple split data streams having corresponding split characteristics based on a configuration of a sensor (e.g., an image sensor). For example, when the configuration of the image sensor indicates staggered high dynamic range (sHDR) photography, a processor may split the input data stream into multiple split data streams with different exposures. When the configuration of the image sensor indicates dual conversion gains (DCG) photography, the processor may split the input data stream into multiple split data streams with lower bit-widths than the bit-width of the input data stream. The multiple split data streams may be transmitted to multiple corresponding processing elements (e.g., image signal processing (ISP) nodes such as front-end engines, back-end engines, or other ISP nodes) to be processed. In addition, when the configuration of the image sensor indicates a concurrent operation with another image sensor, a processor may forward multiple input data streams of multiple imaging sensors to multiple corresponding processing elements.

The disclosed architectures, systems, apparatus, methods and computer-readable media can reduce the total area of a processor (e.g., image signal processor (ISP) or any other suitable processor) and improve processing efficiency due to concurrent and parallel processing of low bit-width or single exposure split data streams rather than processing of high bit-width or multi exposure image data.

In one aspect of the disclosure, a method for image processing includes receiving a first input data stream of a first data characteristic; splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and transmitting the first split data stream and the second split data stream to a first processing element and a second processing element, respectively.

In an additional aspect of the disclosure, an apparatus includes a memory storing processor-readable code; and a processor coupled to the memory. The processor is configured to execute the processor-readable code to cause the processor to perform steps comprising: receiving a first input data stream of a first data characteristic; splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and transmitting the first split data stream and the second split data stream to a first processing element and a second processing element, respectively.

In an additional aspect of the disclosure, an apparatus includes a first image sensor; a second image sensor; and a processor comprising a routing module and a plurality of processing elements, wherein the routing module comprises: a splitter configured to: receive a first input data stream from the first image sensor, and split the first input data stream into a first split data stream and a second split data stream; a first multiplexer configured to: receive the first input data stream and the first split data stream, and select the first input data stream or the first split data stream; and a second multiplexer configured to: receive at least one of: a second data stream or the first split data stream, and select the second data stream or the second split data stream, wherein a first processing element of the plurality of processing elements is configured to process the first split data stream or the first input data stream, and wherein a second processing element of the plurality of processing elements is configured to process the second split data stream or a second input data stream from the second image sensor.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 shows a flow chart of an example method for routing an input data stream according to some embodiments of the disclosure.

FIGS. 4A-4C show example input data streams processed according to some embodiments of the disclosure: FIG. 4A shows an example input data stream as multi-exposure data image data for routing and processing according to some embodiments of the disclosure, FIG. 4B shows an example input data stream as dual conversion gains image data for routing and processing according to some embodiments of the disclosure, and FIG. 4C shows an example input data stream as single exposure and low bit-width image data for routing and processing according to some embodiments of the disclosure.

FIG. 5 shows a block diagram illustrating an example data flow path for signal routing in an image capture device according to one or more embodiments of the disclosure.

FIGS. 6A-6C show a block diagram illustrating data paths using a routing module differently splitting a input data stream into multiple split data streams according to one or more embodiments of the disclosure: FIG. 6A shows a block diagram illustrating the routing module splitting multi-exposure image data into split data streams with different exposures, FIG. 6B shows a block diagram illustrating the routing module splitting dual conversion gains image data into low-bit-width split data streams, and FIG. 6C shows a block diagram illustrating the routing module forwarding multiple input data streams.

FIG. 7 shows an example circuit diagram of an apparatus including a routing module for input data routing according to one or more embodiments of the disclosure.

FIG. 8 shows an example circuit diagram of an apparatus including a routing module for input data routing and a shared module according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

To achieve high image quality with variation in light levels in a scene, an image sensor may improve photography by combining multiple recorded representations of a scene from the image sensor. For example, an image sensor may support dynamic range by using staggered high dynamic range (sHDR) photography or dual conversion gains (DCG) photography to achieve high image quality. In the sHDR photography, an image sensor may generate multiple exposure image data (e.g., using interleaved or time-multiplexed lines), and an image sensor processor (ISP) may process the multiple exposure image data using configurations or algorithms before offline merging to generate a final image. For the sHDR photography, in order to generate one final output image, the total number of pixels the ISP needs to process is twice, thrice, or multiple times as much as the ISP processes non-HDR input image data depending on the number of exposures. The throughput or performance demand on the ISP for the sHDR photography is twice, thrice, or multiple times higher than non-HDR photography, and leads to higher hardware cost and/or higher computational complexity. Similarly, in the DCG photography, an image sensor may generate one image based on double gain levels but with a higher bit width than non-DCG photography because the produced image merges two image signals with a high gain and a low gain. Thus, to process a higher bit width, the ISP uses more processing power and more hardware support.

In one conventional solution, the circuitry for processing image data from an image sensor is designed to match the characteristics of the image data. For example, the bit width of the ISP circuitry is designed to match the highest bit width of the image sensor. To support the processing sHDR or DCG images, the ISP occupies a bigger area of a chip and consumes additional power to process multi-exposure image data and/or higher-bit-width image data. Further, when the image sensor is operating in a non-sHDR or non-DCG mode, the processing capability of the ISP circuitry is unused and needlessly consuming die area and power.

In another conventional solution, ISP circuitry, such as an ISP front-end engine, can be duplicated to support multiple image sensors or multiple image data streams. This ISP circuitry may be made symmetric to reduce engineering effort. Although the symmetric front-end engines can reduce computational complexity, the above-mentioned high hardware cost is duplicated for each concurrent image sensor that a given chip supports and prevent the image capture device from reducing its size due to the additional hardware area to support the multi-exposure image or high-bit image processing.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

The present disclosure provides systems and methods that support image or signal processing, including techniques for routing an input data stream (e.g., an image data stream) into multiple split data streams having corresponding split characteristics based on a configuration of a sensor (e.g., an image sensor). For example, when the configuration of the image sensor indicates staggered high dynamic range (sHDR) photography, a processor may split the input data stream into multiple split data streams with different exposures. When the configuration of the image sensor indicates dual conversion gains (DCG) photography, the processor may split the input data stream into multiple split data streams with lower bit-widths than the bit-width of the input data stream. The multiple split data streams may be transmitted to multiple corresponding processing elements (e.g., image signal processing (ISP) nodes such as front-end engines, back-end engines, or other ISP nodes) to be processed. In addition, when the configuration of the image sensor indicates a concurrent operation with another image sensor, a processor may forward multiple input data streams of multiple imaging sensors to multiple corresponding processing elements.

Particular implementations of the subject matter described in this disclosure may be implemented to realize one or more of the following potential advantages or benefits. In some aspects, the present disclosure provides architectures, systems, apparatus, methods, and computer-readable media that support image or signal processing, including techniques for routing (e.g., splitting or forwarding) an input data stream (e.g., an image data stream) into multiple split data streams having corresponding split characteristics based on a configuration of a sensor (e.g., an image sensor). For example, the disclosed architecture may split a sensor output image into several data streams of lower throughput or less bit-width split streams before the split streams are sent to the ISP front-end processing engine(s). In such examples, the front-end processing engine(s) can use the least-cost solution while the ISP can support different sensors (e.g., sHDR and DCG sensor and multiple concurrent Bayer sensors). The example area saving in a compute chip using the disclosed architecture and techniques can be as high as or more than 0.54 mm² (4 nm, routed), almost 10% of the ISP total area, which is a significant savings.

In addition, the disclosed architecture may receive sensor output data without requiring the sensor decoder, which contains many communication interfaces with software, to modify the process or architecture. Thus, the disclosed architecture may be compatible with the legacy sensor(s) (e.g., sHDR and DCG sensor and/or multiple concurrent Bayer sensors) and save significant software and/or hardware effort to modify the legacy sensor(s). Furthermore, the disclosed architecture may use less computing power to process less throughput or less bit-width split streams than the high throughput or high bit-width input data stream. Hence, the disclosed architectures, systems, and methods may save the operating time of the image capture device using battery power. Furthermore, the disclosed architectures, systems, and methods achieve efficient processing due to the concurrent and parallel processing of multiple split streams, which are low bit-width or single exposure data streams, in multiple processing elements.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

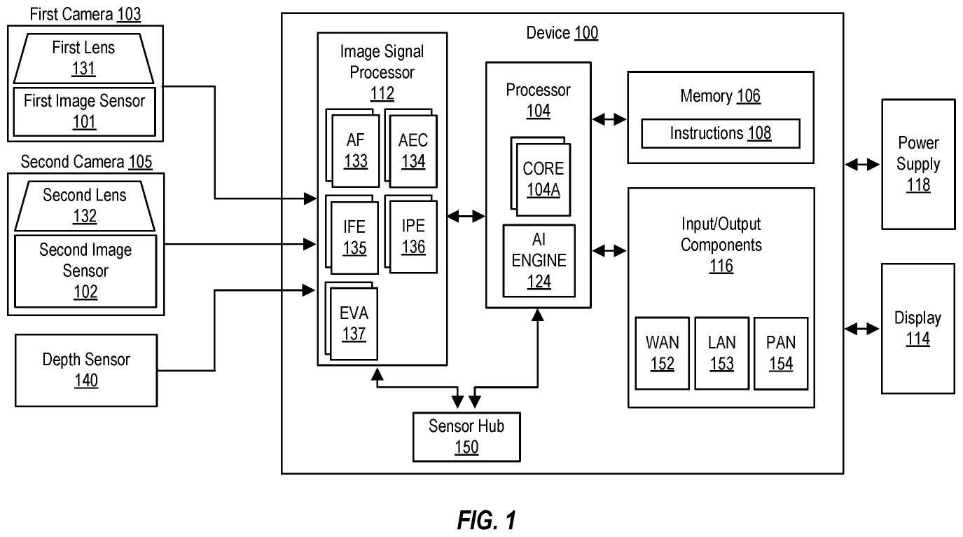

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device 100 may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

In some embodiments, the first image sensor 101 of the first camera 103 may include a staggered high dynamic range (sHDR) sensor, a dual conversion gains (DCG) sensor, and/or a Bayer sensor to produce an input data stream to the ISP 112. For example, the sHDR sensor may produce multi-exposure image data such that multiple images with multiple exposures are merged. In some examples, the multi-exposure image data may include multiple interleaved image data lines with the multiple images having different exposures. The DCG sensor may produce image data based on double gain levels where the DCG image data has a higher bit-width than the bit-width of the non-DCG image data. The Bayer sensor may produce a single exposure and low bit-width image data. In some examples, a configuration of the ISP 112 may specify that the first image sensor 101 and the second image sensor 102 operate concurrently. In some examples, the first lens 131 of the first camera 103 may be associated with one image sensor to generate a data stream or multiple image sensors to generate one or more input data streams. The second image sensor 102 of the second camera 105 may be substantially similar to the first image sensor 101. In some examples, the first image sensor 102 may be symmetric with or be different from the second image sensor 102. In further embodiments, more than two cameras and/or image sensors (e.g., each image sensor including a staggered high dynamic range (sHDR) sensor, a dual conversion gains (DCG) sensor, and/or a Bayer sensor) can produce multiple input data streams.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mm Wave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store an input data stream, multiple split data streams, and/or image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including receiving a first input data stream of a first data characteristic, splitting the first input data stream into a first split data stream and a second split data stream, transmitting the first split data stream and the second split data stream to a first processing element and a second processing element, respectively, and/or processing the first and second split data streams in the first and second processing elements of an image signal processor, respectively. For example, execution of the instructions can instruct the ISP 112 to begin or end capturing an image frame or a sequence of image frames, in which the capture includes correction as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of signal routing (e.g., splitting or forwarding) to the image frame processing. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

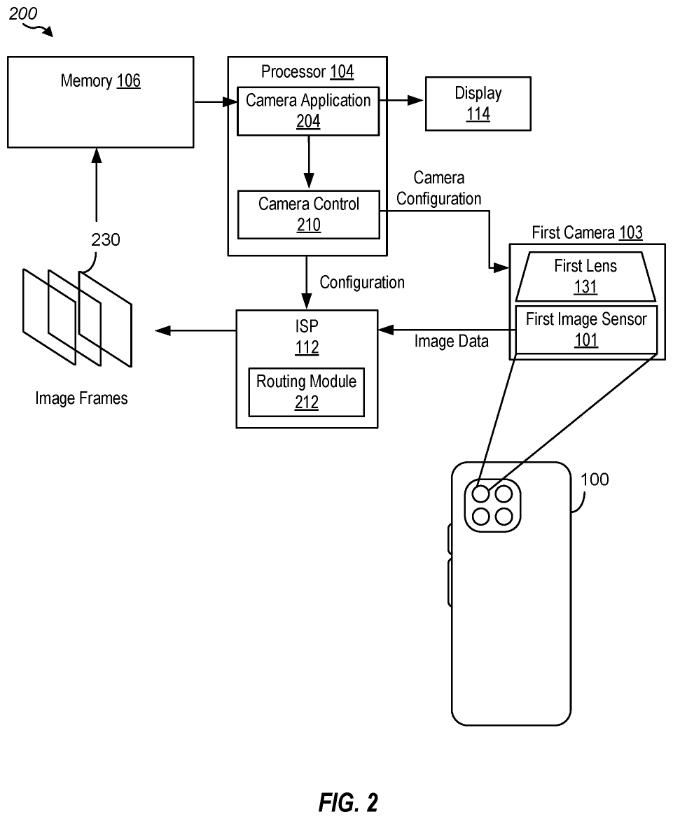

The exemplary image capture device of FIG. 1 may use less chip space for the ISP 112 to support multiple image sensors and less power to operate the image capture device by splitting an input data stream into multiple split data streams with multiple split characteristics, which are different from an input data characteristic of the input data stream. One example method of operating one or more cameras, such as first camera 103 and/or second camera 105, is shown in FIG. 2 and described below.

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration. In some embodiments, the camera configuration may include a configuration. The configuration may include an indication (e.g., a number, character(s), string, symbol(s), or any other suitable indication) to indicate or select an image sensor (e.g., an sHDR sensor, a DCG sensor, a Bayer sensor, multiple Bayer sensors, or any other suitable image sensor) to use and/or indicate a data type (e.g., multi-exposure image data, dual conversion gains image data, concurrent multi-sensor image data, etc.) of the image data. In such examples, the configuration may be manually selected via the camera application 204 or may be automatically selected based one or more parameters (e.g., a user profile, a previous setting, an amount of light incident, and/or etc.).

In some embodiments in which the first camera 103 is a variable aperture (VA) camera system, the processor 104 may execute the camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, high dynamic range (HDR) merging, and/or dual conversion gains (DCG) merging. In some embodiments, the effects may be applied in the ISP 112.

The output image frames 230 by the ISP 112 may include representations of the scene improved in low-light conditions where the ISP 112 may support multiple image sensors with an optimal chip size of the ISP 112 by aspects of this disclosure. The processor 104 may display these output image frames 230 to a user, and the improvements provided by the described processing implemented in the ISP 112 and/or processor 104 reduce the size of the ISP 112 but support multiple image sensors. Thus, the image quality and the user experience may be enhanced by reducing the appearance of bright and dark regions in the photograph due to the multiple image sensor support. For example, routing module 212 in the ISP 112 may split the image data received from the first image sensor 101 into multiple split data streams for multiple processing elements of the ISP 112 (e.g., multiple image front-end engines 135) and/or processor 104 to process the multiple split data streams or concurrently forward the image data from the first image sensor 101 and other image data from other image sensor(s) to corresponding processing elements of the ISP 112 and/or the processor 104 to process the image data and the other image data. Then, the multiple processing elements of the ISP 112 and/or processor 104 produce an output image frame 230. It should be understood that the routing module 212 is not limited to a module in the ISP 112. For example, the routing module 212 may be part of any suitable processor or be separate from but coupled to the processor.

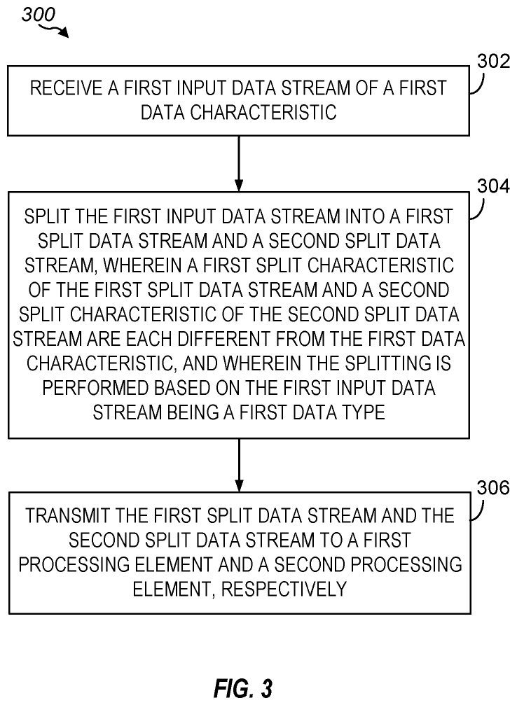

The system 200 of FIG. 2 may be configured to perform the operations described with reference to FIG. 3 to determine output image frames 230. FIG. 3 shows a flow chart of an example method for routing an input data stream according to some embodiments of the disclosure. Each of the operations described with reference to FIG. 3 may be performed by a processor (e.g., one or a combination of the routing module 212 in the ISP 112, image front engine(s) 135 or any module in the ISP 112, processing element(s), and/or the processor 104 including cores 104A-N or AI engine 124). In other examples, the processor may include any other suitable device or integrated circuit to perform each of the operations in FIG. 3.

At block 302, the processor receives a first input data stream of a first data characteristic. For example, the first input data stream may include image data received from a first image sensor (e.g., the first image sensor 101 of the first camera 103). The first input data stream may be received, for example, from a bus coupled to the first image sensor 101 of the first camera 103 or from an analog front end (AFE) coupled to the first camera 103. The first input data stream may alternatively be received from a wireless camera, in which the input data stream is received through one or more of the WAN adaptor 152, the LAN adaptor 153, and/or the PAN adaptor 154. The first image data may alternatively be received from a memory location or a network storage location, such as when the image data was previously captured and is now retrieved from memory 106 and/or a remote location through one or more of the WAN adaptor 152, the LAN adaptor 153, and/or the PAN adaptor 154. In some embodiments, the capture of input data stream or image data may be initiated by a camera application executing on the processor 104, which causes camera control 210 to activate capture of image data by the first camera 103. However, it should be appreciated that the first input data stream is not limited to image data. For example, the first input data stream may include any suitable data stream representing audio, voice, letters, a number, symbols, any suitable data or data stream.

The first data characteristic of the first input data stream may include a data rate, a bit-width, or any other suitable characteristic of the first input data stream. For example, the data rate of the first input data stream may indicate the frequency at which consecutive images, image lines, or data units (e.g., bits, bytes, etc.) are captured by the first image sensor 101. In some scenarios, the data rate may be a rate at which a suitable number of lines are captured by the first image sensor 101 per second (e.g., 1k, 2k, 3k, or any suitable number of lines per second). In some examples, a line that the first image sensor 101 generates may correspond to one pixel in height and multiple pixels in width in an image. In other examples, a line that the first image sensor 101 generates may correspond to multiple pixels in height and multiple pixels in width in an image. The bit-width of the first input data stream may indicate the number of bits used to represent the intensity of each pixel in an image.

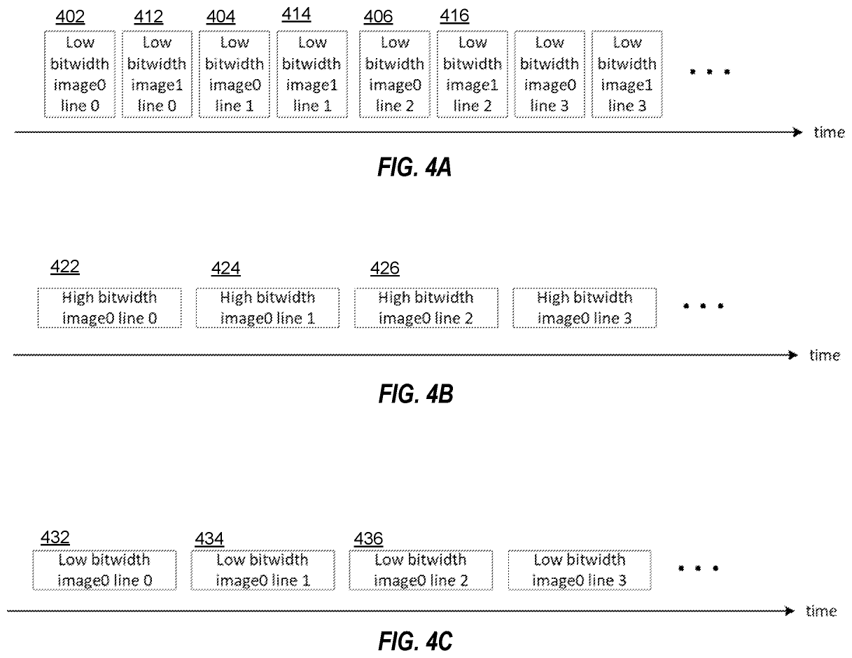

In some embodiments, the processor may receive a configuration of the first image sensor 101, and that configuration may indicate the first data characteristic. For example, the configuration may indicate a data type (multi-exposure image data, dual conversion gains image data, or concurrent multi-sensor image data) of the first input data stream. Alternatively or in addition, the configuration may specify the first image sensor 101 concurrently operating with the second image sensor and/or any other image sensor. FIG. 4A shows an example of the first input data stream for multi-exposure imaging. For example, the configuration may be transmitted to the first image sensor 101 (e.g., from the camera control 210) for the multi-exposure imaging. In such examples, the first image sensor 101 may include a staggered high-dynamic-range (sHDR) sensor or any other suitable sensor for the multi-exposure imaging. The first camera 103 may select the sHDR sensor as the first image sensor 101 based on the configuration. Then, the processor may receive multiple exposure image data as the first input data stream from the first image sensor 101.

In some examples, the first input data stream may include multiple interleaved image data lines. As shown in FIG. 4A, the sHDR sensor may produce multiple interleaved image data lines such that each line of two images (image 0 and image 1) with different exposures is alternatively received. For example, line 0 of image 0 (402) and line 0 of image 1 (412) are sequentially received. Subsequently, line 1 for image 0 (404) and line 1 of image 1 (414) are sequentially received. In this way, the processor may receive the multi-exposure image data (i.e., the first input data stream), which multiplexes multiple exposure images in a line-interleaved and/or time-multiplexed manner. In such examples, the first input data stream includes two images with different exposures using interleaved image data lines. In other examples, the first input data stream includes more than two images (e.g., three, four, five, or any other suitable number) with different exposures using interleaved image data lines. In some examples, one or more predetermined bits may be included at the end of each line to indicate the end of the line. In other examples, any other suitable techniques (e.g., by counting the number of received bits) may be used to indicate the end of a line and/or the image of the line.

FIG. 4B shows an example of the first input data stream for dual conversion gains (DCG) imaging. For example, the configuration may be transmitted to the first image sensor 101 (e.g., from the camera control 210) indicating the image sensor is operating in the dual conversion gains imaging mode. In such examples, the first image sensor 101 may include a dual conversion (DCG) sensor or any other suitable sensor for the dual conversion gains imaging or multiple conversion gains imaging. The first camera 103 may select the DCG sensor as the first image sensor based on the configuration. Then, the processor may receive dual conversion gains image data as the first input data stream from the first image sensor 101. The first input data stream may include one image with a higher bit-width than non-DCG photography because the produced image merges two image signals with a high gain and a low gain. For example, the DCG sensor may produce an image data stream including line 0 (422) of high bit-width image 0, line 1 (424) of high bit-width image 0, line 2 (426) of high bit-width image 0, other lines of high bit-width image 0, and/or other images. In such examples, the first input data stream is for dual conversion gains imaging. In other examples, In other examples, the first input data stream uses more than two gains images (e.g., three, four, five, or any other suitable number of gains).

FIG. 4C shows an example of the first input data stream for concurrent multi-sensor imaging. For example, the configuration may be transmitted to the first image sensor 101 (e.g., from the camera control 210) indicating the image sensor is operating in the concurrent multi-sensor imaging mode. The configuration may specify a second image sensor 102 and/or one or more other image sensors operating concurrently with the first image sensor 101. In such examples, the first image sensor 101 may include a Bayer sensor, a color filter array (CFA) sensor, or any other suitable sensor for the concurrent multi-sensor imaging. The first camera 103 may select the Bayer or CFA sensor as the first image sensor based on the configuration. Then, the processor may receive first image data, which is non-HDR and non-DCG data, as the first input data stream from the first image sensor 101 and receive second image data as a second input data stream from the second image sensor 102. Each of he first and second image data from the Bayer sensors may include single exposure image data and have a lower bit-width than the bit-width of dual conversion gains image data shown in FIG. 4B. For example, the Bayer sensor of the first image sensor 101 may produce an image data stream including line 0 (432) of low bit-width image 0, line 1 (434) of low bit-width image 0, line 2 (436) of low bit-width image 0, other lines of low bit-width image 0, and/or other images. Similarly, another Bayer sensor of the second image sensor 102 may concurrently produce another image data stream. In such examples, the processor may receive the first input data stream and the second input data stream. In other examples, more than two image data streams (e.g., three, four, five, or any other suitable number of data streams).

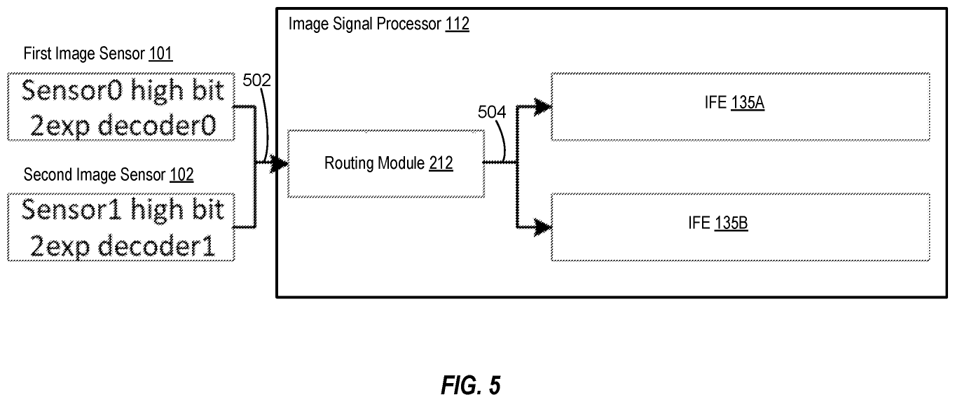

FIG. 5 shows a block diagram illustrating an example data flow path in an image capture device. The block diagram shows multiple sensors including the first and second sensors 101, 102 to produce one or more input data streams (e.g., image data). The one or more input data streams received at block 302 corresponding to a signal path 502 in FIG. 5 may be then processed by a processor (e.g., the routing module 212 of the ISP 112, any other module of the ISP 112, and/or the processor 104 or other means for processing image data) according to the operations described in one or more of the following blocks.

At block 304 of FIG. 3, the processor splits the first input data stream into a first split data stream and a second split data stream. For example, the splitting may be performed (e.g., by the routing module 212 in FIGS. 2 and/or 5) based on the first input data stream being a data type. In some examples, the data type may be determined and/or indicated by a configuration of the first image sensor. The first image sensor 101 may include an sHDR sensor, a DCG sensor, a Bayer sensor, and/or any other suitable sensor for the first image sensor. Thus, the first data type of the first input data stream may include multi-exposure image data associated with the sHDR sensor, DCG image data associated with the DCG sensor, or concurrent multi-sensor image data associated with the Bayer sensor. In other examples, the processor may identify the data type based on a data rate, a bit-width, an indication of concurrent operation of multiple image sensors, any suitable characteristic of the first input data stream, or any other suitable indication.

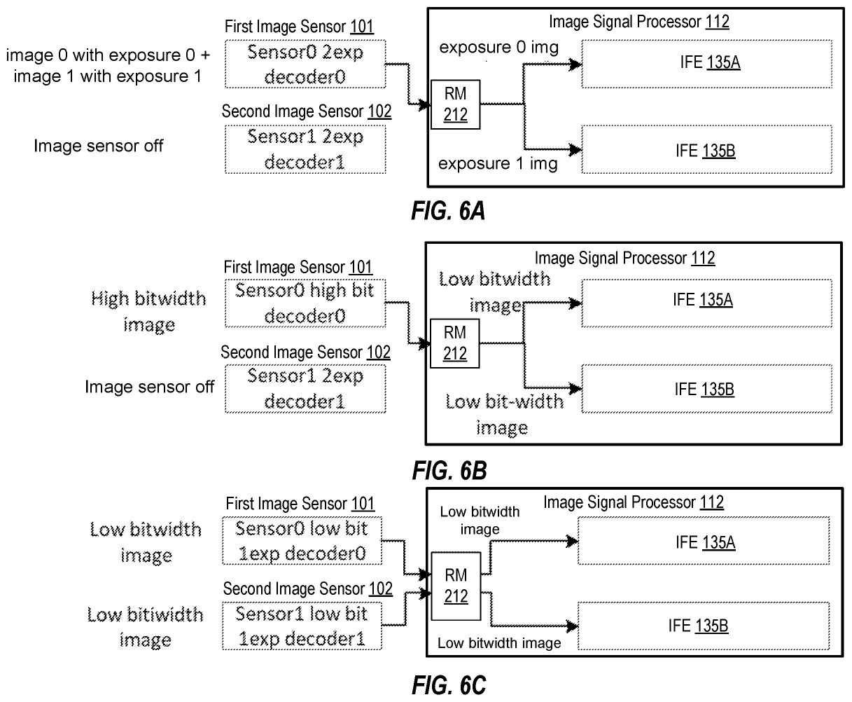

The first data type may be identified and the manner of splitting to the first split data stream and the second split data stream determined based on the first data type. A first split characteristic of the first split data stream and a second split characteristic of the second split data stream may be each different from the first data characteristic. For example, each of the first and second split characteristics may include a data rate, a bit-width, or any other suitable characteristics of the respective split data stream. For example, the first split characteristic and the second split characteristic may be determined by the first data type. This allows the splitting to be reconfigured based on the camera configuration that is coupled to the image signal processor 112. For example, with reference to the embodiments of FIGS. 6A-6C, the image signal processor 112 may determine a camera configuration based on the first data type of image data received at the routing module 212 and reconfigure the routing module 212 according to one of the embodiments of FIGS. 6A-6C. The processor may be configured, for example, as part of block 304 to determine a first data type of the first input data stream and configure the processor into a configuration having a particular first split characteristic and second split characteristic when splitting the first input data stream into a first split data stream and a second split data stream.

Referring again to FIG. 5, the routing module 212 splits the first input data stream 502 into the first and second split data streams 504. In further examples, the routing module 212 may split the first input data stream 502 into more than two split data streams. In further examples, the processor may split the first input data stream into more than two split data streams (e.g., more than two split data streams with different exposure, more than two split data streams with low bit widths).

FIGS. 6A-6C show a block diagram illustrating data paths using a routing module 212 differently splitting an input data stream into multiple split data streams. For example, FIG. 6A shows a block diagram illustrating the routing module 212 splitting multi-exposure image data into split data streams with different exposures. The processor including the routing module 212 may receive the first input data stream, which includes multi-exposure image data, from the first image sensor 101. The multi-exposure image data may include multiple interleave image data lines for multiple images with different exposures for a scene. Based on the data type as multi-exposure image data, the routing module 212 in the processor may split the first input data stream into the first split data stream having a first exposure for a first image of a scene and the second split data stream having a second exposure of a second image of the scene. The first exposure may be different from the second exposure. Here, the exposure (e.g., the first exposure and the second exposure) may indicate an amount of light, which reaches a camera sensor (e.g., the first image sensor 101 and/or the second image sensor 102). In some examples, the exposure can be controlled based on a shutter speed and/or an aperture of the camera lens.

In the example of FIG. 4A, the first input data stream includes multiple interleaved image lines for image 0 and image 1. In this example, the processor may split the first input data stream into the first split data stream including a first data line of the multiple interleaved image lines for image 0 and the second split data stream including a corresponding data line of the multiple interleaved image lines for image 1, wherein the corresponding image data line corresponds to the first image data line. For example, the first split data stream may include line 0 of image 0 (402), line 1 of image 0 (404), line 2 of image 0 (406), and other lines of image 0, and the second split data stream may include line 0 of image 1 (412), line 1 of image 1 (414), line 2 of image 1 (416), and other lines of image 1. Thus, the first split data stream can include multiple lines of image 0 having the first exposure (e.g., exposure 0 in FIG. 6A) while the second split data stream can include multiple lines of image 1 having the second exposure (e.g., exposure 1 in FIG. 6A). In further examples, the processor may split the input data stream into more than two split data streams with different exposures.

For the multi-exposure imaging, the first split characteristic of the first split data stream and the second split characteristic of the second split data stream are each different from the first data characteristic. For example, the first data characteristic may include a first data rate, and each of the first and second split characteristics may include a second data rate. In such examples, the second data rate may be lower than the first data rate. In some scenarios, when the processor receives the first input data stream at the first data rate (e.g., 2,000 lines per second), the processor splits the input data stream into two split data streams at a slower rate (e.g., 1,000 lines per second).

FIG. 6B shows a block diagram illustrating the routing module splitting dual conversion gains image data into low-bit-width split data streams. The processor including the routing module 212 may receive the first input data stream, which includes dual conversion gains image data, from the first image sensor 101. The dual conversion gain image data may include a higher bit-width than non-DCG image data (e.g., the multi-exposure image data or concurrent multi-sensor image data). Based on the data type as dual conversion gains image data, the routing module 212 in the processor may split the first input data stream into the first and second split data streams. The first data characteristic of the first input data stream may include a first bit-width, the first split characteristic of the first split data stream may include a second bit-width, and the second split characteristic of the second split data stream may include a third bit-width. In some examples, the first bit-width is higher than each of the second bit-width and the third bit-width. Thus, the input data stream may use more bits to represent each pixel in an image than the first or second split data stream.

In some examples, the processor may split the input data stream having 16 bits per pixel (i.e., the first bit-width) into a first split data stream having 14 bits per pixel (i.e., the second bit-width) and a second split data stream having 14 bits per pixel (i.e., the third bit-width). In such examples, the processor may split the input data stream into multiple split data streams with a higher bit-width than the half of the bit-width of the input data stream to maintain or improve the image quality when processing the multiple split data streams. In other examples, the processor may split the input data stream into multiple split data streams with the half of the bit-width of the input data stream. The second bit-width may be the same as or be different from the third bit-width. Thus, the high bit-width input image data (i.e., the first input data stream) is split into multiple low bit-width image data streams (i.e., the multiple split data streams) by the routing module 212 of the processor.

In some examples, the processor splits the input data stream differently based on the data type of the input data stream. For example, the processor may receive a configuration of an image sensor (e.g., the first image sensor 101) and determine the data type of the first input data stream based on the configuration. When the data type is multi-exposure image data, the processor generates the first split data stream and the second split data stream to have different exposures as shown in FIG. 6A. When the data type is dual conversion gains image data, the processor split into the first split data stream and the second split data stream to have a lower bit-width than the first input data stream as shown in FIG. 6B.

FIG. 6C shows a block diagram illustrating the routing module forwarding multiple input data streams. For example, each of the first image sensor 101 and the second image sensor in FIG. 6C may include a Bayer sensor for concurrent multi-sensor imaging. In some embodiments, the routing module may not split an input data stream but forward multiple input data streams to multiple corresponding processing elements. In such embodiments, the processor may receive a configuration specifying the first image senor operating concurrently with the second image sensor. Thus, the routing module 212 in the processor may receive the first input stream from the first image sensor 101 and the second input stream from the second image sensor 102 and forward the first input stream and the second input stream to the first processing element and the second processing element, respectively, based on the configuration. In other examples, the routing module 212 may receive more than two input streams (e.g., three, four, or any other suitable input streams) from corresponding image sensors and forward the more than two input streams to more than two corresponding processing elements.

At block 306 of FIG. 3, the processor transmits the first split data stream and the second split data stream to a first processing element and a second processing element, respectively. For example, as shown in Figures, 5, 6A, and 6B, the routing module 212 of the processor may transmit multiple split data streams to multiple corresponding processing elements. A processing element may include a front-end engine 135A, 135B in the ISP 112, an image post-processing engine 136 in the ISP 112, a back-end engine, a remote processor, or any other suitable processor to process a split data stream. In some examples, multiple processing elements may process multiple split data streams to produce a final image or an output. In some examples of the concurrent multi-sensor imaging as shown in FIG. 6C, the processor may not transmit the split data streams but transmit multiple input data streams to multiple corresponding processing elements.

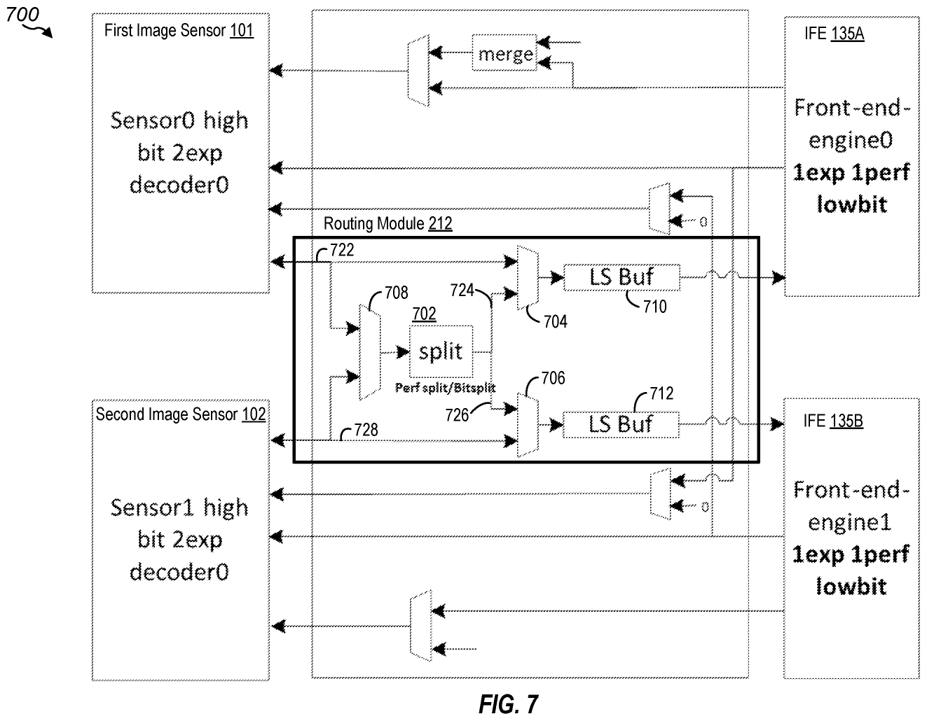

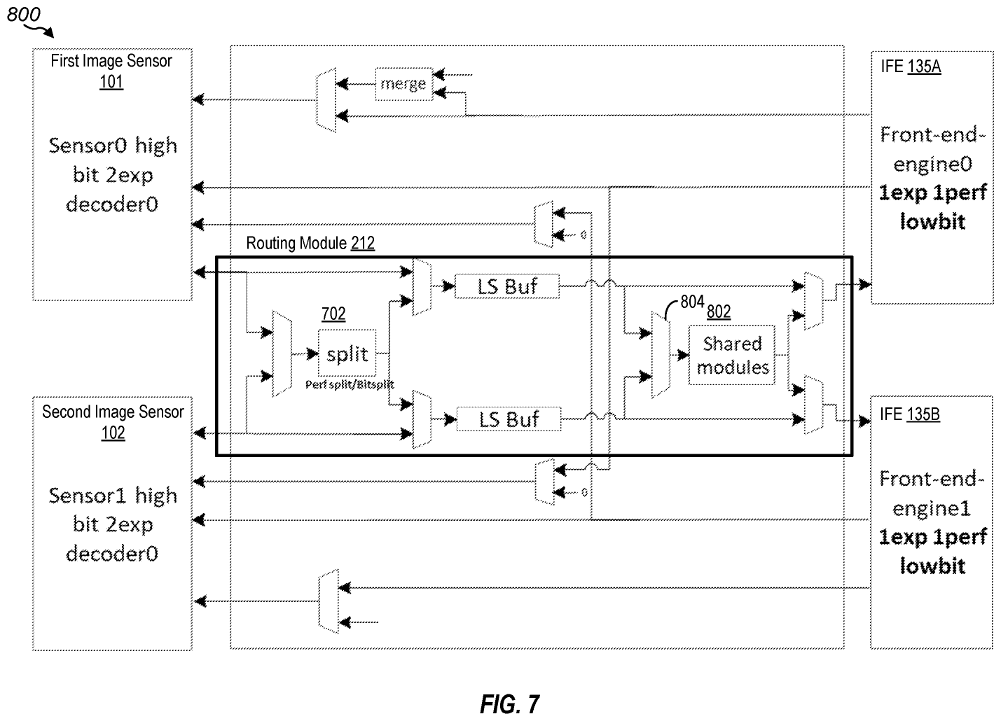

FIG. 7 shows an example circuit diagram of an apparatus including a routing module 212 for input data routing. The circuit diagram including the routing module 212 supports different data types (e.g., multi-exposure image data, dual conversion gains image data, concurrent multi-sensor image data, etc.) of input data streams to split differently or forward the input data stream(s) based on a data type or a configuration of the input data stream(s) as shown in FIGS. 6A-6C. For example, the apparatus 700 may include the first image sensor 101, the second image sensor 102, and a processor. For example, the first image sensor 101 and/or the second image sensor 102 may be a staggered high-dynamic-range sensor configured to produce multi-exposure image data, a dual-conversion-gain sensor configured to produce dual conversion gains image data, a Bayer sensor configured to produce non-sHDR and non-DCG image data. The processor may include the routing module 212 for routing (e.g., splitting or forwarding) the input data stream(s) and multiple processing elements (e.g., front-end engines 135A, 135B of the ISP 112, back-end engines of the ISP 112, or any other suitable processors) for processing multiple split data streams or input data streams.

The routing module 212 may include a splitter 702, a first multiplexer 704, and a second multiplexer 706. The splitter 702 may receive a first input data stream (e.g., the first input data stream in FIG. 3) from the first image sensor 101 and split the first input data stream 722 into a first split data stream 724 (e.g., the first split data stream in FIG. 3) and a second split data stream 726 (e.g., the second split data stream in FIG. 3). In some examples, the routing module may receive a configuration (e.g., the configuration associated with FIG. 3) and determine a data type of the first input data stream 722 based on the configuration, and configure the splitter 702 and the multiplexers 708, 704, and 706 accordingly.

In some embodiments, the splitter 702 may split the first input data stream 722 based on the data type and/or the configuration. For example, when the data type is multi-exposure image data, the first split data stream and the second split data stream may have different exposures. In such examples where the data type is multi-exposure image data, the first input data stream may have a data characteristic of a first data rate, and each of the first split data stream and the second split data stream may have a split characteristic of a second data rate. In such examples, the second data rate is lower than the first data rate. Alternatively or in addition, when the data type is multi-exposure image data, the first input data stream comprises multiple interleaved image data lines, the first split data stream and the second split data stream may include a first image data line of the multiple interleaved image data lines and a subsequent image data line of the multiple interleaved image data lines, respectively. In such examples, the subsequent image data line may correspond to the first image data line. When the first data type is dual conversion gains image data, each of the first split data stream and the second split data stream may have a lower bit-width than the first input data stream. In such examples where the first data type is dual conversion gains image data, the first input data stream has a data characteristic of a first bit-width, and the first split data stream and the second split data stream may have a first split characteristic of a second bit-width and a second split characteristic of a third bit-width, respectively. In such examples, the first bit-width is higher than each of the second bit-width and the third bit-width, and the second bit-width and the third bit-width may be equal or different.

In some examples, an input multiplexer 708 may be further included in the routing module to be electrically coupled to the splitter 702 and the first and second image sensors 101, 102. Here, a multiplexer may be a combinational logic circuit designed to switch one of multiple inputs to a single common output. The input multiplexer 708 may select the first input data stream 722 from the first image sensor 101 or a second input data stream 728 from the second image sensor. Thus, the routing module 212 may select the input image data to be from the first image sensor 101 or the second image sensor. In some examples, when there are more than two image sensors, the input multiplexer 708 may select one input image data from more than two image sensors.

The first multiplexer 704 may be electrically coupled to the splitter 702 and the first image sensor 101. The first multiplexer 704 may receive the first input data stream and the first split data stream, and select the first input data stream or the first split data stream. The second multiplexer 706 may be electrically coupled to the splitter 702 and the second image sensor 102. The second multiplexer 706 may receive at least one of: a second data stream or the first split data stream, and select the second data stream or the second split data stream. For example, when the data type is multi-exposure image data or dual conversion gains image data, the first multiplexer may select the first split data stream based on the configuration, and the second multiplexer may select the second split data stream. In some examples, the routing module may receive a configuration specifying the first image sensor operating concurrently with the second image sensor. In such examples, the first multiplexer is configured to select the first input data stream, and the second multiplexer is configured to select the second input data stream. Then, each of the first image sensor and the second image sensor may include a Bayer sensor.

In some examples, the apparatus may further include a first buffer to receive the first split data stream 724 for smoothening the first split data stream and a second buffer to receive the second split data stream for smoothening the second split data stream. For example, when the data type is the multi-exposure image data, the splitter 702 splits the multiple interleaved image data lines. For example, the first, third, fifth, and other odd number of lines of the interleaved image data lines may be the first split data stream while the second, fourth, sixth, and other even number of lines of the interleaved lines may be the second split data stream. While the even number of data lines are generated for the second split data stream, the first multiplexer 704 does not receive data. The first buffer 710 may duplicate the first data line for the period of the second data line. The second buffer 712 is similar to the first buffer 710 such that the second buffer 712 may duplicate the even number of data lines for the periods of the odd number of data lines. Thus, the first and second buffers 710, 712 may align output from the first split data stream and the second split data stream.

Multiple processing elements (e.g., front-end engines 135A, 135B of the ISP 112, back-end engines of the ISP 112, or any other suitable processors) for processing multiple split data streams or input data streams. For example, when the data type is multi-exposure image data or dual conversion gains image data, the multiple processing elements may process multiple split data streams corresponding to the multiple processing elements. When the data type is concurrent multi-sensor image data or the configuration specifies that multiple sensors concurrently operate, the multiple processing elements may process multiple input data streams corresponding to the multiple processing elements. Since multiple processing elements concurrently process multiple low bit-width or single exposure data streams, the processing elements do not need additional circuit to support high bit-width or multi-exposure data streams. Thus, the total area of the processor including the processing elements can be significantly reduced by 10%. Also, the concurrent and parallel processing of multiple split data streams reduces the processing time of the input data stream, which is a high bit-width or multi-exposure data stream.

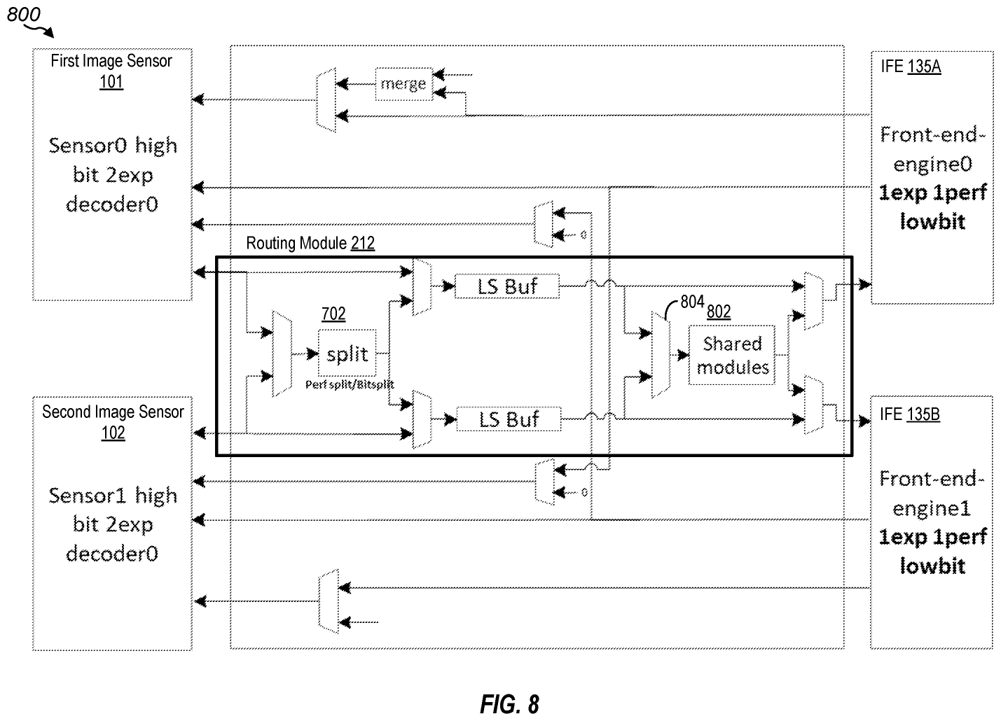

One or more shared modules may be included as part of the routing module 212 to perform identical or similar operations on one or more split streams of data before routing to separate processing elements. FIG. 8 shows an example circuit diagram of an apparatus 800 including a routing module 212 for input data routing and a shared module 802. The apparatus 800 includes a shared module 802 in addition to the apparatus 700 in FIG. 7. In some examples, the shared module 802 may include an autofocus module to process input data stream and provide supportive information to software for sensor focus setting adjustment, a quad phase detection re-mosaic module to perform re-mosaic or binning on input data stream (e.g., in color filter array (CFA) to produce a Bayer output before feeding into the IFE 135, or any other suitable module to support functions of the image sensor 101, 102.

In one or more aspects, techniques for supporting image processing may include additional aspects, such as any single aspect or any combination of aspects described below or in connection with one or more other processes or devices described elsewhere herein. In a first aspect, supporting image processing may include a method comprising: receiving a first input data stream of a first data characteristic; splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and transmitting the first split data stream and the second split data stream to a first processing element and a second processing element, respectively.

In a second aspect, in combination with the first aspect, the first input data stream comprises image data, and the method further comprises: processing the first split data stream in the first processing element of an image signal processor; and processing the second split data stream in the second processing element of the image signal processor.

In a third aspect, in combination with one or more of the first aspect or the second aspect, the first split data stream has a first exposure for a first image of a scene, the second split data stream has a second exposure for a second image of the scene, and the first exposure is different from the second exposure.

In a fourth aspect, in combination with one or more of the first aspect through the third aspect, the first data characteristic comprises a first data rate, and each of the first split characteristic and the second split characteristic comprises a second data rate, and the second data rate is lower than the first data rate.

In a fifth aspect, in combination with one or more of the first aspect through the fourth aspect, the first input data stream comprises a plurality of interleaved image data lines, the first split data stream comprises a first image data line of the plurality of interleaved image data lines, and the second split data stream comprises a subsequent image data line of plurality of interleaved image data lines, the subsequent image data line corresponding to the first image data line.

In a sixth aspect, in combination with one or more of the first aspect through the fifth aspect, the splitting of the first input data stream comprising: splitting the first input data stream into the first split data stream, the second split data stream, and one or more additional split data streams, the transmitting of the first split data stream and the second split data stream comprising: transmitting the first split data stream, the second split data stream, and one or more additional split data streams to the first processing element, the second processing element, and one or more processing elements, respectively, and the one or more additional split data streams has one or more additional exposures for one or more additional images of the scene.

In a seventh aspect, in combination with one or more of the first aspect through the sixth aspect, the first data characteristic of the first input data stream comprises a first bit-width, the first split characteristic of the first split data stream comprises a second bit-width, the second split characteristic of the second split data stream comprises a third bit-width, and the first bit-width is higher than each of the second bit-width and the third bit-width.

In an eighth aspect, in combination with one or more of the first aspect through the seventh aspect, the method further comprises: receiving a configuration of a image sensor; and determining the first data type of the first input data stream based on the configuration, when the first data type is multi-exposure image data, the first split data stream and the second split data stream have different exposures, and wherein when the first data type is dual conversion gains image data, each of the first split data stream and the second split data stream has a lower bit-width than the first input data stream.

In a ninth aspect, in combination with one or more of the first aspect through the eighth aspect, the first input data stream is received from a first image sensor, the method further comprises: receiving a new configuration specifying the first image sensor operating concurrently with a second image sensor; receiving a second input data stream from the second image sensor; and transmitting the first input data stream and the second input data stream to the first processing element and the second processing element, respectively, based on the new configuration.

In a tenth aspect, alone or in combination with one or more of the first aspect through the ninth aspect, an apparatus comprises a memory storing processor-readable code; and a processor coupled to the memory, the processor configured to execute the processor-readable code to cause the processor to perform steps comprising: receiving a first input data stream of a first data characteristic; splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and transmitting the first split data stream and the second split data stream to a first processing element and a second processing element, respectively.

In an eleventh aspect, in combination with one or more of the first aspect through the tenth aspect, an apparatus comprises a first image sensor, a second image sensor, and the processor comprising a routing module and a plurality of processing elements. The routing module comprises: a splitter configured to: receive a first input data stream from the first image sensor, and split the first input data stream into a first split data stream and a second split data stream; a first multiplexer configured to: receive the first input data stream and the first split data stream, and select the first input data stream or the first split data stream; and a second multiplexer configured to: receive at least one of: a second data stream or the first split data stream, and select the second data stream or the second split data stream, wherein a first processing element of the plurality of processing elements is configured to process the first split data stream or the first input data stream, and wherein a second processing element of the plurality of processing elements is configured to process the second split data stream or a second input data stream from the second image sensor.

In a twelfth aspect, in combination with one or more of the first aspect through the eleventh aspect, the routing module is configured to: receive a configuration; and determine a data type of the first input data stream based on the configuration, wherein the first input data stream is split based on the data type, wherein the first image sensor is a staggered high-dynamic-range sensor configured to produce multi-exposure image data or a dual-conversion-gain sensor configured to produce dual conversion gains image data.

In a thirteen aspect, in combination with one or more of the first aspect through the twelfth aspect, the data type is multi-exposure image data or dual conversion gains image data, the first multiplexer is configured to select the first split data stream, the second multiplexer is configured to select the second split data stream, the first processing element of the plurality of processing elements is configured to process the first split data stream, and the second processing element of the plurality of processing elements is configured to process the second split data stream.

In a fourteenth aspect, in combination with one or more of the first aspect through the thirteen aspect, the data type is multi-exposure image data, and the apparatus further comprises: a first buffer configured to receive the first split data stream for smoothening the first split data stream, and a second buffer configured to receive the second split data stream for smoothening the second split data stream.

In a fifteenth aspect, in combination with one or more of the first aspect through the fourteenth aspect, the routing module is configured to receive a configuration specifying the first image sensor operating concurrently with the second image sensor, the first multiplexer is configured to select the first input data stream, the second multiplexer is configured to select the second input data stream, the first processing element of the plurality of processing elements is configured to process the first input data stream, the second processing element of the plurality of processing elements is configured to process the second input data stream.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIGS. 5-8 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving a first input data stream of a first data characteristic;
splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and
transmitting the first split data stream and the second split data stream to a first processing element and a second processing element, respectively.

2. The method of claim 1, wherein the first input data stream comprises image data, and
wherein the method further comprises:
processing the first split data stream in the first processing element of an image signal processor; and
processing the second split data stream in the second processing element of the image signal processor.

3. The method of claim 2, wherein the first split data stream has a first exposure for a first image of a scene,
wherein the second split data stream has a second exposure for a second image of the scene, and
wherein the first exposure is different from the second exposure.

4. The method of claim 3, wherein the first data characteristic comprises a first data rate,
wherein each of the first split characteristic and the second split characteristic comprises a second data rate, and
wherein the second data rate is lower than the first data rate.

5. The method of claim 3, wherein the first input data stream comprises a plurality of interleaved image data lines,
wherein the first split data stream comprises a first image data line of the plurality of interleaved image data lines, and
wherein the second split data stream comprises a subsequent image data line of plurality of interleaved image data lines, the subsequent image data line corresponding to the first image data line.

6. The method of claim 3, wherein the splitting of the first input data stream comprising: splitting the first input data stream into the first split data stream, the second split data stream, and one or more additional split data streams,
wherein the transmitting of the first split data stream and the second split data stream comprising: transmitting the first split data stream, the second split data stream, and one or more additional split data streams to the first processing element, the second processing element, and one or more processing elements, respectively, and
wherein the one or more additional split data streams has one or more additional exposures for one or more additional images of the scene.

7. The method of claim 2, wherein the first data characteristic of the first input data stream comprises a first bit-width,
wherein the first split characteristic of the first split data stream comprises a second bit-width,
wherein the second split characteristic of the second split data stream comprises a third bit-width, and
wherein the first bit-width is higher than each of the second bit-width and the third bit-width.

8. The method of claim 1, further comprising:
receiving a configuration of an image sensor; and
determining the first data type of the first input data stream based on the configuration,
wherein when the first data type is multi-exposure image data, the first split data stream and the second split data stream have different exposures, and
wherein when the first data type is dual conversion gains image data, each of the first split data stream and the second split data stream has a lower bit-width than the first input data stream.

9. The method of claim 1, wherein the first input data stream is received from a first image sensor, and
wherein the method further comprises:
receiving a new configuration specifying the first image sensor operating concurrently with a second image sensor;
receiving a second input data stream from the second image sensor; and
transmitting the first input data stream and the second input data stream to the first processing element and the second processing element, respectively, based on the new configuration.

10. An apparatus comprising:
a memory storing processor-readable code; and
a processor coupled to the memory, the processor configured to execute the processor-readable code to cause the processor to perform steps comprising:
receiving a first input data stream of a first data characteristic;
splitting the first input data stream into a first split data stream and a second split data stream, wherein a first split characteristic of the first split data stream and a second split characteristic of the second split data stream are each different from the first data characteristic, and wherein the splitting is performed based on the first input data stream being a first data type; and
transmitting the first split data stream and the second split data stream to a first processing element and a second processing element, respectively.

11. The apparatus of claim 10, wherein the first input data stream comprises image data, and
wherein the processor is further configured to perform steps further comprising:
processing the first split data stream in the first processing element of an image signal processor; and
processing the second split data stream in the second processing element of the image signal processor.

12. The apparatus of claim 11, wherein the first split data stream has a first exposure for a first image of a scene,
wherein the second split data stream has a second exposure for a second image of the scene,
wherein the first exposure is different from the second exposure,
wherein the first input data stream comprises a plurality of interleaved image data lines,
wherein the first split data stream comprises a first image data line of the plurality of interleaved image data lines, and
wherein the second split data stream comprises a subsequent image data line of plurality of interleaved image data lines, the subsequent image data line corresponding to the first image data line.

13. The apparatus of claim 12, wherein the first data characteristic comprises a first data rate,
wherein each of the first split characteristic and the second split characteristic comprises a second data rate, and
wherein the second data rate is lower than the first data rate.

14. The apparatus of claim 11, wherein the first data characteristic of the first input data stream comprises a first bit-width,
wherein the first split characteristic of the first split data stream comprises a second bit-width,
wherein the second split characteristic of the second split data stream comprises a third bit-width, and
wherein the first bit-width is higher than each of the second bit-width and the third bit-width.

15. The apparatus of claim 11, wherein the first input data stream is received from a first image sensor, and
wherein the processor is further configured to perform steps comprising:
receiving a new configuration specifying the first image sensor operating concurrently with a second image sensor;
receiving a second input data stream from the second image sensor; and
transmitting the first input data stream and the second input data stream to the first processing element and the second processing element, respectively, based on the new configuration.

16. An apparatus comprising:
a first image sensor;
a second image sensor; and
a processor comprising a routing module and a plurality of processing elements, wherein the routing module comprises:
a splitter configured to:
receive a first input data stream from the first image sensor, and
split the first input data stream into a first split data stream and a second split data stream;
a first multiplexer configured to:
receive the first input data stream and the first split data stream, and
select the first input data stream or the first split data stream; and
a second multiplexer configured to:
receive at least one of: a second data stream or the first split data stream, and
select the second data stream or the second split data stream,
wherein a first processing element of the plurality of processing elements is configured to process the first split data stream or the first input data stream, and
wherein a second processing element of the plurality of processing elements is configured to process the second split data stream or a second input data stream from the second image sensor.

17. The apparatus of claim 16, wherein the routing module is configured to:
receive a configuration; and
determine a data type of the first input data stream based on the configuration,
wherein the first input data stream is split based on the data type, and
wherein the first image sensor is a staggered high-dynamic-range sensor configured to produce multi-exposure image data or a dual-conversion-gain sensor configured to produce dual conversion gains image data.

18. The apparatus of claim 17, wherein the data type is multi-exposure image data or dual conversion gains image data,
wherein the first multiplexer is configured to select the first split data stream,
wherein the second multiplexer is configured to select the second split data stream,
wherein the first processing element of the plurality of processing elements is configured to process the first split data stream, and
wherein the second processing element of the plurality of processing elements is configured to process the second split data stream.

19. The apparatus of claim 17, wherein the data type is multi-exposure image data, and
wherein the apparatus further comprises:
a first buffer configured to receive the first split data stream for smoothening the first split data stream, and
a second buffer configured to receive the second split data stream for smoothening the second split data stream.

20. The apparatus of claim 16, wherein the routing module is configured to receive a configuration specifying the first image sensor operating concurrently with the second image sensor,
wherein the first multiplexer is configured to select the first input data stream,
wherein the second multiplexer is configured to select the second input data stream,
wherein the first processing element of the plurality of processing elements is configured to process the first input data stream, and
wherein the second processing element of the plurality of processing elements is configured to process the second input data stream.
